(19) United States
(12) Patent Application Publication
(10) Pub. No.: US 2009/0057058 A1
(43) Pub. Date: Mar. 5, 2009

(54) Drain plug and method of use

(75) Inventor: Blaise Meyers, Gales Ferry, CT (US)

Correspondence Address: HEDMAN & COSTIGAN P.C., 1185 AVENUE OF THE AMERICAS, NEW YORK, NY, 10036, US

(73) Assignee: The Weinberger Group

(21) Appl. No.: 11/899,087

(22) Filed: Sep. 4, 2007

(51) Int. Cl. F16C 3/14; F01M 11/04

(52) U.S. Cl. 184/1.5; 123/196 R

(57) ABSTRACT

A drain plug including a spring activated sealing piston to control the flow of fluid. The drain plug is formed of an assembly body with one or more apertures from the exterior to a central cavity, a sealing piston for sealing the openings and a spring for maintaining the sealing piston is a sealed relationship with the openings until a compressive force is applied to the sealing piston. The drain plug allows for a controlled flow of fluid from a fluid receptacle and makes possible a method for rapidly and safely draining fluid, such as used oil from an engine oil pan or other source. Also, a method of draining fluid using the drain plug.

### FIELD OF THE INVENTION

The invention relates generally to the field of drain plugs and more specifically drain plugs and methods of their use for facilitating the changing of oil in a vehicle.

### BACKGROUND OF THE INVENTION

Changing automobile engine oil is often a dirty and potentially dangerous task. Replacing the oil in a vehicle engine usually necessitates access to the underside of a vehicle. This usually requires a mechanic to crawl under a vehicle or to have it raised. Additionally, manufacturers recommend changing oil when it is warm so as to lower the viscosity. This usually necessitates running the engine for a certain amount of time prior to draining the oil. However, the oil can become extremely hot inside a running engine and, if run for too long, the drained oil can burn a mechanic.

Additionally, when drain plugs are inconveniently orientated it is possible to spill oil on the work room floor or to increase the chance that the mechanic will be burned by the hot oil.

Typically, in order for an oil change to be effected, the oil drain plug must be unscrewed from the oil pan and the oil drained. It is of great importance that the oil plug be screwed back into the oil pan with the proper degree of tightness. Over-tightening of the oil plug could result in cracking of the plug or oil pan. Under-tightening of the oil plug results in oil leaks, loss of the drain plug and/or potential damage to the engine.

What is necessary is an apparatus and method of changing oil in a controlled manner that prevents the high potential for mess and potential danger encountered with traditional means. Additionally, what is needed is an apparatus and method that removes the uncertainty surrounding how much torque is necessary to properly re-secure an oil cap.

The prior art has tried, and failed, to remedy the drawbacks encountered when changing engine oil. For example, U.S. Pat. No. 5,411,115 to Shropshire describes an oil drain plug that uses a push and twist engagement to provide the closed and open configurations maintained by the device. A spout member is present to allow for connection of a hose or tube for draining. This apparatus, however, fails to provide a means for draining oil in a controlled manner. Once the plug has been disengaged, it is incapable of controlling the flow of oil without difficulty.

U.S. Pat. No. 6,318,500 to Mizani et al. describes an apparatus that is threaded into an inlet port of an oil drain plug. The apparatus has a center member that, when aligned with the top and bottom of the apparatus, allows for the flow of oil. When the center member is not aligned, the oil is prevented from draining out of the oil pan. This apparatus lacks a low profile design and requires a number of parts to successfully operate.

U.S. Pat. No. 6,902,038 to Takahara describes an oil drain plug that allows for the draining of oil from the oil pan of a car engine. The device uses a dedicated jig assembly so as to open a normally closed valve in order to drain the oil contained in the oil pan. This is accomplished by extracting the oil with negative pressure. A movable valve disc member installed in the through hole is installed so that it is engaged with a valve seat provided near the outer end part of the through hole by a coiled spring so as to form the normally closed valve. Takahara fails to use a piston compression device as well as failing to utilize a low profile design.

U.S. Pat. No. 5,667,195 to McCormick is directed to a fluid drain apparatus that includes a quick drain assembly which may be permanently installed on a fluid tank or receptacle. The patent describes a cooperating, quickly attachable and releasable, connector assembly which mates with the drain assembly. McCormick does not implement a low profile drain plug assembly. Furthermore, McCormick requires a new opening in the tank. Additionally, McCormick does not enable fine control over the amount of fluid drained.

The prior art, however, fails to provide for the preferred device and method that uses a low profile drain plug in an existing oil drain aperture to allow for the safe and rapid changing of oil.

### SUMMARY OF THE INVENTION

The present invention is directed to a new and unique drain plug that enables an improved method of draining used oil from engines or other sources in a controlled manner. This new and unique drain plug also prevents the usual mess encountered with traditional methods.

The oil drain plug is comprised of a cylindrical drain plug assembly body having a proximal and a distal end and a central cavity. The distal end is at least partially closed and the proximal end is at least partially open. The exterior surface of the assembly body possesses a plurality of openings arranged to allow a fluid to pass from the exterior of the drain plug to the central cavity.

The drain plug assembly body preferably has a configuration head located at the proximal end of the assembly body shaped so as to allow mating with a tightening tool for installing the drain plug assembly into a receiving opening. The configuration head is shaped so as to permit access to the central cavity of the cylindrical drain plug assembly body.

The new and unique drain plug of the present invention employs several components located inside the cylindrical drain plug assembly body. The drain plug incorporates a spring which preferably rests upon at least a portion of the distal end of the cylindrical assembly body. A piston plug rests upon the spring, and is located so that when the spring is not under compression the piston plug blocks and seals the plurality of openings found in the cylindrical assembly body. The drain plug also employs a compression tool retainer which is fitted in the open end of the assembly body and is secured from rotational movement by a retention pin.

In a most preferred embodiment, the said compression tool retainer possesses an interior cavity that is preferably threaded and is open at both ends.

A piston compression tool is used to operate the apparatus. The piston compression tool compresses a passage there through and is to be inserted into the compression tool retainer. When fully inserted, the piston compression tool moves the piston plug out of alignment. This in turn allows the oil to flow into the cylindrical drain plug assembly body and, preferably, out through the piston compression tool.

A sealing cap preferably replaces the piston compression tool it seal the drain plug between fluid changes. Preferably, the sealing cap includes a gasket for a maintaining a leak free seal and is mounted flush with the assembly for a low profile when not in use.

### BRIEF DESCRIPTION OF THE DRAWINGS

The attached drawing figures, in which like reference characters represent like parts, are included solely to illustrate the preferred embodiment of the present invention without limiting the invention in any manner whatsoever, wherein:

FIG. 1 is a perspective view of a low-profile drain plug assembly with the sealing cap installed.

FIG. 2 is a perspective view of a low profile drain plug assembly, partially transparent, with the piston compression tool installed.

FIG. 3 is an exploded view of the low-profile drain plug assembly and piston compression tool.

FIG. 4 is an exploded view of the low-profile drain plug assembly and sealing cap.

FIG. 5 is a cross section side elevation of the low profile drain plug assembly with the sealing cap installed.

FIG. 6 is a cross section side elevation of the low profile drain plug assembly with the piston compression tool partially threaded into the drain plug assembly.

### DETAILED DESCRIPTION OF THE PRESENT INVENTION

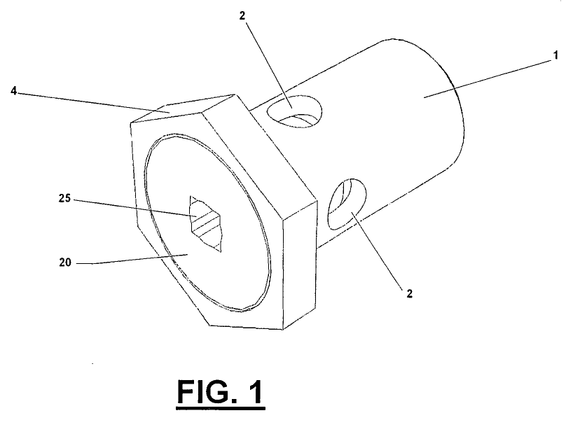

As shown in the Figures, and particularly FIG. 1, the preferred embodiment of the present invention is directed to a low-profile drain plug assembly. The preferred assembly comprises a hollow drain plug cylinder (or assembly body cylinder) (1) with apertures (2) cut into the sides of the assembly body cylinder (1). One end of the assembly body cylinder (1) is generally closed and the other end is generally open. The open end can be cast, machined, or otherwise formed into a configuration head (4) for insertion and removal from a receiving opening, such as a threaded drain hole on an automobile oil pan.

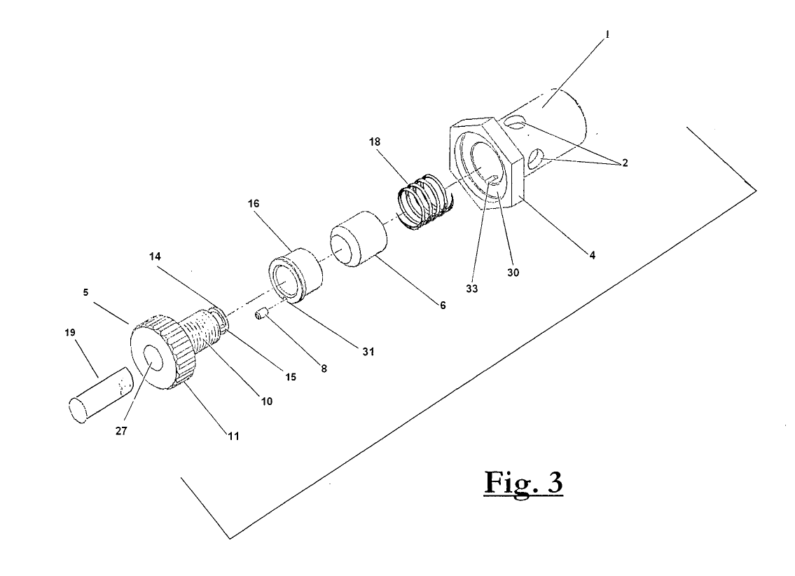

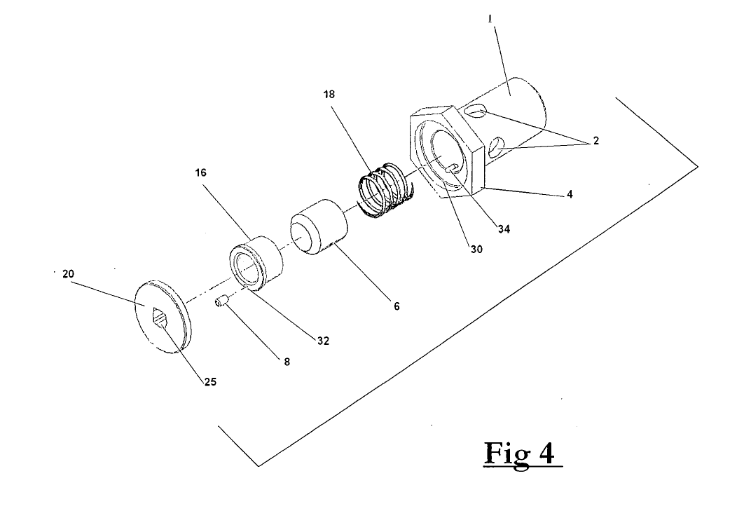

The shape of the configuration head (4), when used for insertion and removal of the device on a receiving opening, is determined by the type of tool used to insert and tighten the entire apparatus into the drain pan, but is preferably hexagonal as is standard in the industry. The configuration head (4) itself has an opening that permits access to the interior of the cylinder (1). The face of the configuration head (4) preferably possesses a recessed portion (30) around the opening to the interior of the cylinder (1), as shown is FIGS. 3 and 4. This recessed portion is designed so that a sealing cap (20) may be placed over the opening to the interior of the cylinder (1) and fit flush with the rest of the configuration head (4) between oil changes.

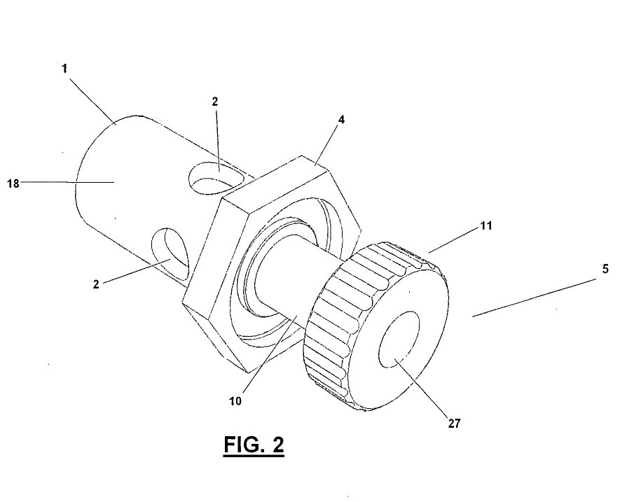

As shown in FIGS. 2-6, a spring (18) is placed inside of the assembly body cylinder (1) and is made to rest on the closed end of the cylinder (1). A piston plug (6), a small solid cylinder slightly smaller in diameter than the interior of the assembly body cylinder (1), is placed inside the assembly cylinder (1) body on top of the spring (18). The piston plug (6) and the spring (18) are configured so that when the piston plug (6) is placed on top of the spring (18) the piston plug (6) covers the apertures (2) cut into the sides of the assembly body cylinder (1).

The piston plug (6) and the interior of the assembly body cylinder (1) form an oil-tight seal that prevents oil from flowing through the apertures (2) into the interior of the assembly body (1). The effectiveness of the seal is due in part to the fact that the apertures (2) are sized so that the piston plug (6) blocks the entirety of the apertures (2).

A piston retention cap (16) is placed inside the assembly body cylinder (1). The piston retention cap (16) is a hollow cylinder, roughly the diameter of the piston plug (6), with one end slightly flared. The interior surface of the hollow piston retention cap (16) is threaded so as to allow installation and drainage components to be screwed into the piston retention cap (16). The flared end of the piston retention cap (16) is designed so that the piston retention cap (16) fits securely in the assembly body cylinder (1) and is prevented from moving vertically. The bottom end secures the piston plug (6) so that it rests firmly on the spring (16) and maintains the seal preventing the flow of oil.

As best seen in FIG. 4, a semi-circular notch (32) is preferably located in the flared end of the piston retention cap. This notch (32) is mated with a small cylindrical retention pin (8). The retention pin (8) fits partially into a small depression (34) corresponding to the size of the retention pin (8) formed in the wall of the drain plug cylinder (1). The retention pin (8) therefore prevents the piston retention cap (16) from rotating when objects are threaded through its center.

When operation of the drain plug assembly is desired, a user will remove the sealing cap (20) and insert a piston compression tool (5) into the drain plug assembly, preferably by threading the piston compression tool (5) into the piston retention cap (16). The piston compression (5) tool is preferably made up of an elongated hollow cylindrical body (10), a piston stand off ring (14) and a larger adjustment head (11). The adjustment head (11) is sized so that part of the head fits into the recessed portion (30) of the configuration head (4) when fully threaded. Additionally, the adjustment head (11) has as opening (27) roughly the diameter of the elongated hollow cylindrical body (10).

The elongated hollow cylindrical body (10) possesses threads on the exterior of the cylinder, terminating at the adjustment head (11) on one end and a piston stand-off ring (14) at the other end. The stand off ring (14) is separated from the end of the hollow cylindrical body (10) by shafts of material (15). This allows the piston stand-off ring (14) to exert a force on the piston plug (6) but prevents the piston stand-off ring (14) from blocking the flow of oil into the hollow cylindrical body (10).

Preferably, at least a portion of the opening (27) of the adjustment head (11) is adapted for accepting a hose (19), preferably being threaded for accepting cooperating threads on a hose (19) to direct the flow of oil. It is understood that the cooperating hose (19) can be any suitable length and made of any suitable material, with a flexible material for directing the discharge as desired by the user.

As referred to above, when the piston compression tool (5) is not in use, a sealing cap (20) is provided to cover opening of the configuration head (4). The cap (20) is sufficiently shaped so that it fits flush with the rest of the configuration head (4) when placed in the recessed portion (30). Additionally, said cap (20) has a depression (25) in the center of the cap. Said depression (25) allows the insertion of a removal tool (not shown) which extracts the cap (20) from the flush configuration head (4).

When the piston compression tool (5) is used, the hollow cylindrical body (10) is threaded into the piston retention cap (16) by manually turning the adjustment head (11). As the hollow cylindrical body (11) is threaded farther into the piston retention cap (16), the piston stand-off ring (14) will eventually come into contact with the piston plug (6). The continuing pressure from the stand-off ring (14) causes the piston plug (6) to compress the spring (18). As the piston (6) compresses the spring (18), the piston plug (6) is moved out of alignment with the apertures (2) cut into the sides of the assembly body cylinder (1).

As will be understood by those skilled in the art, the volume of flow is dependent on how far the piston plug (6) is pushed across the apertures (2). Compressing the spring (18) only slightly may leave only a small portion of the apertures (2) uncovered, resulting in a light flow. However, fully compressing the spring (19) will result in the apertures (2) being fully open, for maximum flow.

When a user desires to install and use the drain plug assembly of the present invention, the user begins by removing the existing drain plug from the oil pan. An assembly body cylinder (1), with the cap (20) installed, is inserted into the existing oil pan drain. A user then simply uses widely available tools to tighten the configuration head (4) to manufacturer's specification.

As shown in FIG. 2, when it is time to drain the engine oil, the sealing cap (20) is removed and the piston compression tool (5) is threaded onto the piston retention cap (16) fitted inside the assembly body cylinder (1).

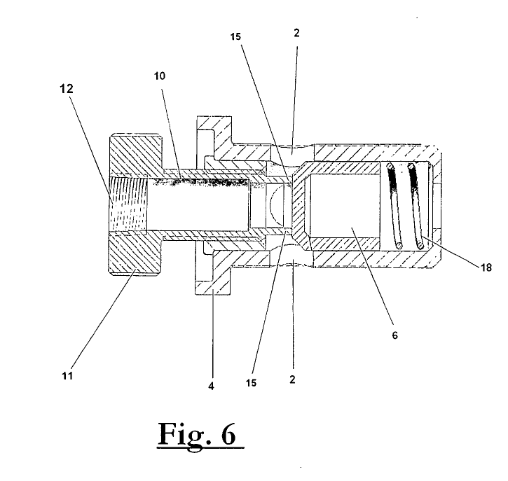

As shown in FIG. 6, when operation of the present apparatus is desired, the elongated hollow cylindrical body (10) is threaded into the piston retention cap (16). As the cylindrical body (10) is threaded into the piston retention cap (16), the piston stand-off ring (14) pushes on piston plug (6), which in turn compresses the spring (18). When the piston plug (6) has fully compressed spring (18), the apertures (2) are no longer blocked by the piston plug (6), and oil is free to flow from the drain pan.

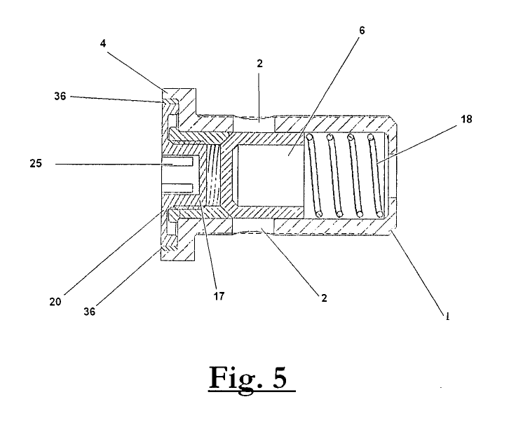

As shown in FIG. 5, when not actively draining oil from an oil pan reservoir, the sealing cap (20) is threaded into the piston retention cap (16), fitted within the recessed portion (30) of the configuration head (4). The sealing cap (20) exerts no force on the piston plug (6), therefore, the piston plug (6) continues to cover the apertures (2) of the assembly body cylinder (1) inhibiting the flow of oil. Preferably, a gasket (36) is located between the sealing cap (20) and the configuration head (4) to provide for an oil-tight seal and to prevent residual leakage.

All of the parts of the present invention are preferably constructed of a durable, non-corroding, oil resistant material such as steel or hard plastics. The exterior of the assembly body cylinder (1) can be threaded, grooved or smooth depending on the particular make and model of automobile oil pan. Additionally, FIG. 1 shows a hex shaped configuration head (4), however, any number of configuration head shapes may be used with the present invention. Similarly, the shape(s) of the one or more apertures (2) is not limited to circles, but can be any shape that allows the flow of oil into the central cavity of the assembly body cylinder (1). Furthermore, depending on the size and shape of the apertures (2), it would be possible to locate more than the two (2) shown in the figures.

The preferred compression tool is also preferably constructed out of a durable, non-corroding, oil resistant material as is the assembly body cylinder (1). The interior of the elongated hollow cylindrical body (10) preferably has a ⅛ NPT threaded passage (12) for accepting a drainage hose (19). In such an embodiment, a ⅛ NPT cooperating barbed hose fitting could be threaded and secured to the threaded passage (12). A suitable length of ¼ I.D. flexible tubing can be fitted to the barbed hose fitting that reaches from the drain plug to a receptacle which will be used to contain waste oil.

The sealing cap (20) is preferably likewise constructed out of a durable, non-corroding, oil resistant material, as is the assembly body cylinder (1). The gasket (36) can be formed of any suitable gasket material, and is preferably constructed out of a durable plastic, rubber, or synthetic rubber-like material. The gasket (36) is preferably shaped to fit into a recess on the configuration head (4) or the sealing cap 20, or both, so as to allow the sealing cap (20) to fit flush with the configuration head (4).

The preferred sealing cap (20) possess on its bottom surface an elongated portion (17) that can fit securely inside the piston retention cap (16). This elongated portion (17) possesses threads so that it is able to be threaded into the piston retention cap (16). This prevents the sealing cap (20) from separating from the cylindrical assembly body (1). The sealing cap (20) possess on its top surface a receiving notch (25) that is capable of receiving a tightening or torque tool such as a screwdriver or hex driver. The receiving notch (25) allows a user to remove or replace the sealing cap (20) with widely available tools.

Having described the present invention, it will now be apparent that many changes and modifications may be made to the above-described embodiments without departing from the spirit and the scope of the present invention.

1. A drain plug, comprising:
a drain plug assembly body having a proximal end, a distal end and a central cavity, said distal end being at least partially closed and said proximal end being at least partially open, said assembly body further comprising one or more apertures arranged to allow a fluid to pass from the exterior of the drain plug assembly body into to the central cavity;
a sealing piston adapted to block and seal the one or more apertures of the drain plug assembly body;
a spring for retaining the sealing piston in a sealed configuration over the apertures when the spring is in an expanded state.

2. The drain plug of claim 1, further comprising a sealing cap adapted to cover the proximal end of the drain plug assembly body when the drain plug is not in use.

3. The drain plug of claim 1, further comprising a piston compression tool for exerting a force upon the sealing piston, which in turn compresses the spring, said piston compression tool comprising an axial opening for permitting a flow of fluid from the central cavity through the length of the piston compression tool.

4. The drain plug of claim 3, wherein the axial opening of the piston compression tool is adapted to accept a hose fitting associated with a proximal end of the piston compression tool.

5. The drain plug of claim 1, further comprising a piston retention cap which is fitted in the at least partially open end of the assembly body.

6. The drain plug of claim 5 wherein the piston retention cap is secured from rotational movement by a retention pin, said piston retention cap including an interior cavity that is open at both ends of said piston retention cap.

7. The drain plug of claim 5, further comprising a piston retention cap whose interior cavity is at least partially threaded.

8. The drain plug of claim 7, wherein the exterior of the piston compression tool is threaded so as to allow secure insertion into the threaded interior cavity of the piston retention cap.

9. The drain plug of claim 3, wherein the piston compression tool further comprises a piston stand-off ring attached to an end of the axial opening so as to come in contact with at least a portion of the sealing piston.

10. The drain plug of claim 3, wherein the piston compression tool is further characterized by possessing an adjustment head that allows for insertion and extraction of the axial cavity.

11. The drain plug of claim 1 further comprising a configuration head at the proximal end of the drain plug assembly body.

12. The drain plug of claim 11 wherein the configuration head is formed of a shape adapted to be engaged by a tool for installation and removal of the drain plug assembly body on a fluid container.

13. The drain plug of claim 11 where the configuration head comprises a recess for accepting the sealing cap in a substantially flush configuration.

14. A drain plug comprising:
a drain plug assembly body having a proximal end, a distal end and a central cavity, said distal end being at least partially closed and said proximal end being at least partially open, and further comprising one or more apertures arranged to allow a fluid to pass from the exterior of the drain plug assembly body into to the central cavity;
a sealing piston adapted to block and seal the one or more apertures found in the cylindrical drain plug assembly body;
a spring for retaining the sealing piston in a sealed configuration when the spring is in an expanded state;
a piston retention cap which is fitted in the open end of the assembly body and is secured from rotational movement by a retention pin, said piston retention cap including an interior cavity that is at least partially threaded and is open at both ends;
a piston compression tool for exerting a force upon the sealing piston, said piston compression tool comprising an axial opening for permitting the flow of fluid from the central cavity through the length of the piston compression tool, said piston compression tool further comprising an adjustment head so as to allow manual activation of the piston compression tool, a piston stand-off ring located at an end of the piston compression tool opposite the adjustment head and a hose fitting for attaching a hose so as to allow drained fluid to be directed to a receptacle.

15. A method for draining fluid from a fluid receptacle in a controlled manner, comprising the steps of:
removing a sealing cap from a drain plug comprising a drain plug assembly body, a sealing piston and a spring;
threading a piston compression tool relative to the drain plug assembly body so that the piston compression tool exerts a force on the sealing piston;
continuing to thread the piston compression tool so that the sealing piston compresses the spring to permit the flow of fluid through one or more apertures on the drain plug assembly body, into a central cavity of the drain plug assembly body and through the piston compression tool.

16. The method of claim 15, further comprising attaching a hose to a proximal end of the piston compression tool prior to completely threading the piston compression tool relative to the drain plug assembly body.

17. The method of claim 16, further comprising directing the fluid discharged from the hose to a user designated fluid receptacle.
